(19) United States
(12) Patent Application Publication
(10) Pub. No.: US 2025/0254547 A1
(43) Pub. Date: Aug. 7, 2025

(54) CONDITIONAL CONNECTION ESTABLISHMENT FAILURE (CEF) REPORT LIST

(71) Applicant: Telefonaktiebolaget LM Ericsson (publ), Stockholm (SE)

(72) Inventors: Ali PARICHEHREHTEROUJENI, Svärtinge (SE); Marco BELLESCHI, Solna (SE); Angelo CENTONZA, Granada (ES); Sakib BIN REDHWAN, Linköping (SE)

(21) Appl. No.: 18/854,999

(22) PCT Filed: Apr. 7, 2023
(86) PCT No.: PCT/IB2023/053585

§ 371 Date: Oct. 8, 2024

Related U.S. Application Data
(60) Provisional application No. 63/328,986, filed on Apr. 8, 2022.

(51) Int. Cl. H04W 24/08

(52) U.S. Cl. CPC H04W 24/08

(57) ABSTRACT

A method performed in a user equipment, UE includes responsive to experiencing a first connection establishment failure, CEF, logging information related to the first CEF as part of a CEF report. The method includes experiencing a second CEF. The method includes responsive to the second CEF occurring in a different cell than a cell where the first CEF occurred: logging the CEF report as an entry of a CEF report list; and updating the CEF report with information associated with the second CEF.

### TECHNICAL FIELD

The present disclosure relates generally to communications, and more particularly to communication methods and related devices and nodes supporting CEF reports.

### BACKGROUND

### Connection Establishment Failure (CEF) Report

The user equipment (UE) logs failed radio resource control (RRC) connection establishments for long term evolution (LTE), universal mobile telecommunications system (UMTS) and new radio (NR). A log is created when the RRC connection establishment procedure fails. For NR, the UE logs any failed connection establishment attempt, i.e., a log is created when the RRC setup or resume procedure fails. The UE logs failed RRC connection establishments without the need for prior configuration by the network.

The UE stores the selected PLMN (public land mobile network) on the RRC connection establishment failure or RRC resume procedure failure. Only if that PLMN is the same as the registered PLMN (RPLMN), the UE may report the log.

The trigger for creating a log related to a failed RRC connection establishment is for NR when timer T300 expires, for LTE when timer T300 expires and for UMTS when V300 is greater than N300. The trigger for creating log related to a failed RRC resume procedure is for NR when timer T319 expires.

Further description of the CEF report can be found in the 3rd Generation Partnership Project (3GPP) technical specification (TS) 37.320.

The CEF report is stored in the UE using the variable VarConnEstFailReport.

### VarConnEstFailReport

The UE variable VarConnEstFailReportList includes a list of the connection establishment failure information and/or connection resume failure information.

### VarConnEstFailReport UE Variable

```
-- ASN1START
-- TAG-VARCONNESTFAILREPORT-START
VarConnEstFailReport-r16 ::= SEQUENCE {
  connEstFailReport-r16 ,
  plmn-Identity-r16 PLMN-Identity
}
-- TAG-VARCONNESTFAILREPORT-STOP
-- ASN1STOP
```

The ConnEstFailReport information element (IE) is defined as:

```
ConnEstFailReport-r16 ::= SEQUENCE {
  measResultFailedCell-r16 ,
  locationInfo-r16 OPTIONAL,
  measResultNeighCells-r16 SEQUENCE {
  measResultNeighCellListNR MeasResultList2NR-r16 OPTIONAL,
  measResultNeighCellListEUTRA MeasResultList2EUTRA-r16
  OPTIONAL
  },
  numberOfConnFail-r16 INTEGER (1..8),
  perRAInfoList-r16 ,
  timeSinceFailure-r16 ,
  ...
}
```

The UE sends the CEF report to the network upon a specific request. The relevant excerpt from 3GPP TS 38.331 is:
1> if connEstFailReportReq is set to true and the UE has connection establishment failure or connection resume failure information in VarConnEstFailReport and if the RPLMN is equal to plmn-Identity stored in VarConnEstFailReport:
   2> set timeSinceFailure in VarConnEstFailReport to the time that elapsed since the last connection establishment failure or connection resume failure in NR;
   2> set the connEstFailReport in the UEInformationResponse message to the value of connEstFailReport in VarConnEstFailReport;
   2> discard the connEstFailReport from VarConnEstFailReport upon successful delivery of the UEInformationResponse message confirmed by lower layers;

It is apparent that the TimeSinceFailure IE is a mandatory IE and if the UE populates a CEF report, the UE adds the TimeSinceFailure IE during reporting towards the network.

Further details of the procedure of generating and reporting can be found in TS 38.331.

Current progress in 3GPP

In 3GPP, it was discussed that UE would log and report a list of CEF reports to the network. The following agreements were reached:
1. Multiple CEF reports is introduced to solve the problem about UL/DL coverage imbalance. For future study (FFS) is whether UE capability is applied. FFS is how to limit the overhead during running CR.
2. Only one PLMN is allowed in multiple CEF reports and the UE clears stored connection establishment/resume failure information upon logging a CEF report in a cell with a different RPLMN identity
3. PerRAInfoList is included in CEF report when multiple CEF is stored.
4. Existing availability bit and request bit is reused for multiple CEF reports.
5. When the UE occurs a new CEF, if the failed cell id of the CEF is the same as the failed cell id in the last entry in VarConnEstFailReportList, the UE replaces the last CEF report with the new CEF report and the numberOfConnFail is summed. Otherwise (two cell ids are different), the UE appends the new CEF into VarConnEstFailReportList

Furthermore, in the ongoing change request (CR) work of TS 38.331 [3], the following was added in section 5.3.3:
2> if the UE supports multiple CEF report:
   3> if the cgi-Info in the measResultFailedCell in the newly added VarConnEstFailReport is the same as the cgi-Info in the measResultFailedCell in the last entry in the VarConnEstFailReportList:
      4> except for the numberOfConnFail, replace all information elements for the entry with the VarConnEstFailReport:
      3> else:
         4> if the maxCEFReport-r17 has not been reached:
         5> append the VarConnEstFailReport as a new entry in the VarConnEstFailReportList

Similar to the CEF report, a new variable, VarConnEstFailReportList has been introduced where the UE would store the list of CEF reports. However, each element of VarConnEstFailReportList is the legacy VarConnEstFailReport.

### VarConnEstFailReportList

The UE variable VarConnEstFailReportList includes a list of the connection establishment failure and/or connection resume failure information.

### VarConnEstFailReportList UE Variable

```
-- ASN1START
-- TAG-VARCONNESTFAILREPORTLIST-START
VarConnEstFailReportLIST-r17 ::= SEQUENCE {
  connEstFailReportList-r17 SEQUENCE (SIZE (1..maxCEFReport-r17))
  OF
VarConnEstFailReport-r16
}
-- TAG-VARCONNESTFAILREPORTLIST-STOP
-- ASN1STOP
```

In addition, when it comes to reporting the CEF reports, the UE upon receiving the CEF report request from the network side, sends both the CEF report and CEF report list to the network. This is shown in the following excerpt from the implemented running change request [R2-2204209] where the changes from the change request are double underlined.

### UE Information

Reception of the UEInformationRequest message

Upon receiving the UEInformationRequest message, the UE shall, only after successful security activation:
1> if the idleModeMeasurementReq is included in the UEInformationRequest and the UE has stored VarMeasIdleReport that contains measurement information concerning cells other than the PCell:
   2> set the measResultIdleEUTRA in the UEInformationResponse message to the value of measReportIdleEUTRA in the VarMeasIdleReport, if available;
   2> set the measResultIdleNR in the UEInformationResponse message to the value of measReportIdleNR in the VarMeasIdleReport, if available;
   2> discard the VarMeasIdleReport upon successful delivery of the UEInformationResponse message confirmed by lower layers;
1> if the logMeasReportReq is present and if the RPLMN is included in plmn-IdentityList stored in VarLogMeasReport:
   2> if VarLogMeasReport includes one or more logged measurement entries, set the contents of the logMeasReport in the UEInformationResponse message as follows:
      3> include the absolute TimeStamp and set it to the value of absoluteTimeInfo in the VarLogMeasReport;
      3> include the traceReference and set it to the value of traceReference in the VarLogMeasReport;
      3> include the traceRecordingSessionRef and set it to the value of traceRecordingSessionRef in the VarLogMeasReport;
      3> include the tce-Id and set it to the value of tce-Id in the VarLogMeasReport;
      3> include the logMeasInfoList and set it to include one or more entries from the VarLogMeasReport starting from the entries logged first, and for each entry of the logMeasInfoList that is included, include all information stored in the corresponding logMeasInfoList entry in VarLogMeasReport;
      3> if the VarLogMeasReport includes one or more additional logged measurement entries that are not included in the logMeasInfoList within the UEInformationResponse message:
         4> include the logMeasAvailable;
         4> if bt-LocationInfo is included in locationInfo of one or more of the additional logged measurement entries in VarLogMeasReport that are not included in the logMeasInfoList within the UEInformationResponse message:
         5> include the logMeasAvailableBT;
         4> if wlan-LocationInfo is included in locationInfo of one or more of the additional logged measurement entries in VarLogMeasReport that are not included in the logMeasInfoList within the UEInformationResponse message:
         5> include the logMeasAvailable WLAN;
1> if ra-ReportReq is set to true and the UE has random access related information available in VarRA-Report and if the RPLMN is included in plmn-IdentityList stored in VarRA-Report:
   2> set the ra-ReportList in the UEInformationResponse message to the value of ra-ReportList in VarRA-Report;
   2> discard the ra-ReportList from VarRA-Report upon successful delivery of the UEInformationResponse message confirmed by lower layers;
1> if rlf-ReportReq is set to true:
   2> if the UE has radio link failure information or handover failure information available in VarRLF-Report and if the RPLMN is included in plmn-IdentityList stored in VarRLF-Report:
      3> set timeSinceFailure in VarRLF-Report to the time that elapsed since the last radio link failure or handover failure in NR;
      3> set the rlf-Report in the UEInformationResponse message to the value of rlf-Report in VarRLF-Report;
      3> discard the rlf-Report from VarRLF-Report upon successful delivery of the UEInformationResponse message confirmed by lower layers;
   2> else if the UE is capable of cross-RAT RLF reporting as defined in TS 38.306 and has radio link failure information or handover failure information available in VarRLF-Report of TS 36.331 and if the RPLMN is included in plmn-IdentityList stored in VarRLF-Report of TS 36.331:
      3> set timeSinceFailure in VarRLF-Report of TS 36.331 to the time that elapsed since the last radio link failure or handover failure in EUTRA;
      3> set failedPCellId-EUTRA in the rlf-Report in the UEInformationResponse message to indicate the PCell in which RLF was detected or the source PCell of the failed handover in the VarRLF-Report of TS 36.331;
      3> set the measResult-RLF-Report-EUTRA in the rlf-Report in the UEInformationResponse message to the value of rlf-Report in VarRLF-Report of TS 36.331;
      3> discard the rlf-Report from VarRLF-Report of TS 36.331 upon successful delivery of the UEInformationResponse message confirmed by lower layers;
1> if connEstFailReportReq is set to true and the UE has connection establishment failure or connection resume failure information in VarConnEstFailReport or VarConnEstFailReportList and if the RPLMN is equal to plmn-Identity stored in VarConnEstFailReport:
   2> set timeSince Failure in VarConnEstFailReport to the time that elapsed since the last connection establishment failure or connection resume failure in NR;
   2> set the connEstFailReport in the UEInformation Response message to the value of connEstFailReport in VarConnEstFailReport;
   2> for each connEstFailReport in the connEstFailReportList in the UEInformationResponse message, set the value to the value of connEstFailReport in VarConnEstFailReport in VarConnEstFailReportList;
   2> discard the connEstFailReport from VarConnEstFailReport and VarConnEstFailReportList upon successful delivery of the UEInformationResponse message confirmed by lower lavers;

### SUMMARY

There currently exist certain challenge(s). According to the current implementation of the UE behavior captured as part of the Running Change Request of the Rel 17 radio resource control (RRC) specification [R2-2204209] section 5.7.10 highlighted above using double underlines, the UE shall report to the network the CEF report and multiple CEF report list at the same time, the connection establishment failure information is requested by the network as part of UE Information Request/Response procedure. This may lead to duplicated information reported by the UE as the content of the CEF report can be the equal to the content of the last (the most recent) entry in the CEF report list.

In addition, the network node receiving multiple CEF report lists does not have any proper action specified about the received CEF report and CEF report list. For example, if the network node receiving the CEF report in which its content is equal to the last item as multiple CEF reports (according to the current UE implementation) and distribute it to other RAN nodes (e.g., the RAN node in which the CEF was occurred), the latter or the operations, administration and maintenance (OAM)/trace collection entity (TCE) may interpret the duplicated CEFs as two distinct reports which may lead to wrong coverage analysis (example of such wrong analysis could be that a coverage hole issue may be measured as too severe, than what it actually is).

Certain embodiments may provide one or more of the following technical advantage(s). The various embodiments solve one of the drawbacks of current specifications. The various embodiments provide options to avoid sending duplicate CEF reports either at the UE side or the network side.

According to other embodiments, a method performed in a user equipment (UE) includes responsive to experiencing a first connection establishment failure, CEF, logging CEF related information as part of the CEF report. The method includes experiencing a second CEF. The method includes responsive to the second CEF occurring in a different cell than a cell where the first CEF occurred: logging the CEF report as an entry of the CEF report list and updating the CEF report with information associated with the second CEF.

According to further embodiments, a method performed in a network node includes receiving a connection establishment failure, CEF, report and a CEF report list from a user equipment (UE). The method includes determining if a CEF logged as part of the CEF report is a same CEF logged to any CEF logged as part of an entry in the CEF report list. The method includes responsive to the CEF logged as part of the CEF report is the same CEF logged as part of an entry in the CEF report list: removing one of the CEF logged as part of the CEF report or the CEF logged as part of an entry in the CEF report list and transmitting the other of the one of the CEF logged as part of the CEF report or the CEF logged as part of an entry in the CEF report list not removed towards a second network node with the CEF report list. The method includes responsive to the CEF logged as part of the CEF report is not equal to a CEF logged as part of an entry in the CEF report list: forwarding each CEF reported in the CEF report and the CEF report list towards corresponding network nodes in which the CEFs occurred based on a cell identifier provided in the CEF reports.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a signaling diagram of an exemplary scenario in which the CEF report content and the CEF report list are different, so the UE shall send both reports to the network according to some embodiments;

FIG. 2 is a signaling diagram of an exemplary scenario in which the CEF report content and the CEF report list are the same (i.e., duplicate entries), so the UE shall send one of the CEF report and the CEF report list to the network and discard the other one according to some embodiments;

FIGS. 3-6 are flow charts illustrating operations of a user equipment according to some embodiments;

FIG. 7 is a signaling diagram of a network node receiving CEF information and removing duplicate information according to some embodiments;

FIG. 8-9 are flow charts illustrating operations of a network node according to some embodiments;

FIG. 10 is a block diagram of a communication system in accordance with some embodiments;

FIG. 11 is a block diagram of a user equipment in accordance with some embodiments

FIG. 12 is a block diagram of a network node in accordance with some embodiments;

FIG. 13 is a block diagram of a host computer communicating with a user equipment in accordance with some embodiments;

FIG. 14 is a block diagram of a virtualization environment in accordance with some embodiments; and

FIG. 15 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, the UE shall report to the network the CEF report and multiple CEF report lists at the same time, where the CEF information is requested by the network as part of a UE Information Request/Response procedure. This may lead to duplicated information reported by the UE as the content of the CEF report can be the equal to the content of the last (the most recent) entry in the CEF report list.

In addition, the network node receiving multiple CEF report lists does not have any proper action specified about the received CEF report and CEF report lists. For example, if the network node receiving the CEF report in which its content is equal to the last item as multiple CEF reports (according to the current UE implementation) and distribute it to other RAN nodes (e.g., the RAN node in which the CEF was occurred), the latter or the OAM/TCE may interpret the duplicated CEFs as two distinct reports which may lead to wrong coverage analysis (example of such wrong analysis could be that a coverage hole issue may be measured as too severe, than what it actually is).

In the various embodiments described below, either the UE or the network node (e.g., radio access network node) discard the duplicated information and measurements provided as part of CEF reports. Some embodiments avoid collecting the duplicated CEF reports.

In addition, the embodiments described herein for the network node enables the network node to dispatch and send the multiple CEF reports received as part of CEF report list to other network nodes or to the TCE/OAM.

Moreover, the method proposed for the network node enables the network node to discard the duplicated CEF reports or flag the reports as duplicated before dispatching and sending to the other network nodes or TCE/OAM.

Other embodiments enable the UE to ensure that there is no duplicate information during creation of the reports.

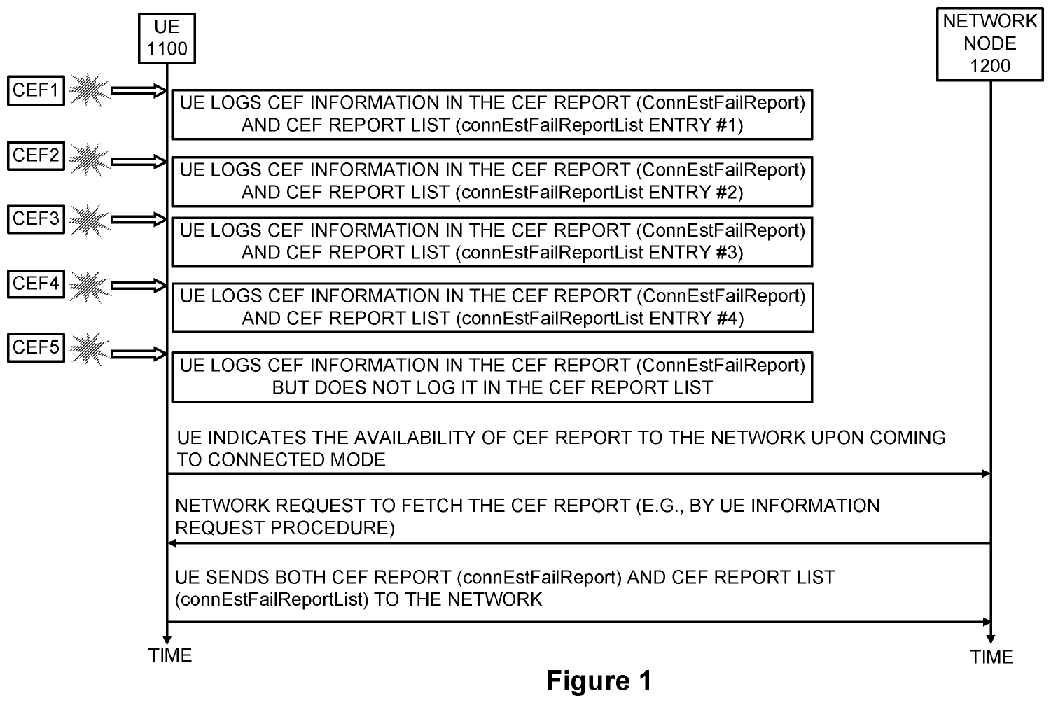

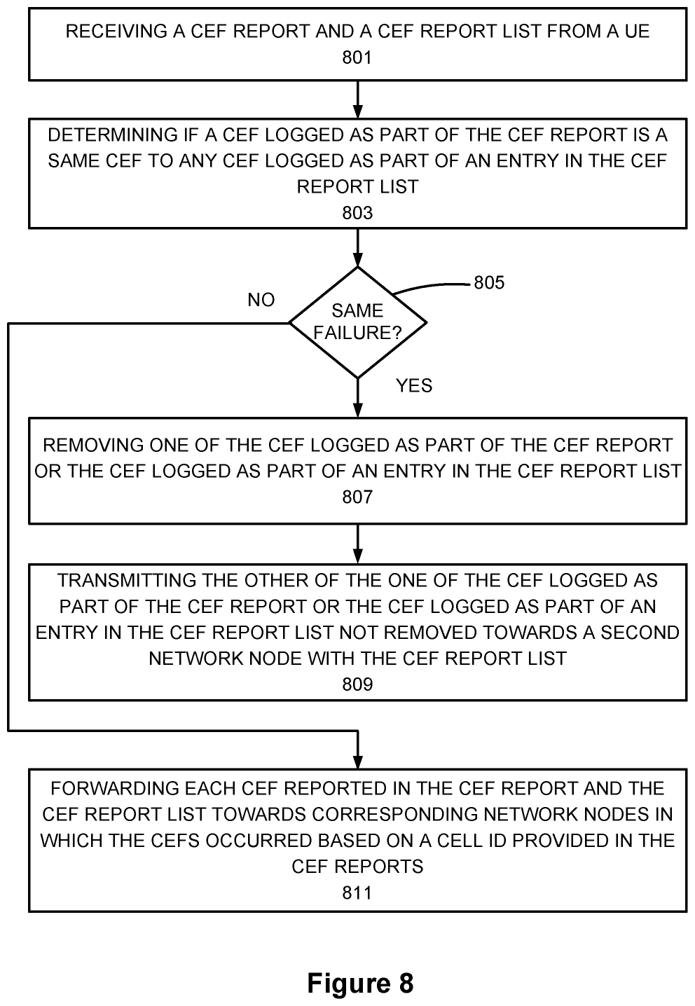

Operations of the user equipment 1100 (implemented using the structure of the block diagram of FIG. 11) will now be discussed with reference to the signaling diagrams and flow charts of FIGS. 1 to 6 according to some embodiments. For example, modules may be stored in memory 1110 of FIG. 11, and these modules may provide instructions so that when the instructions of a module are executed by respective UE processing circuitry 1102, the UE 1100 performs respective operations of the flow chart. Network node 1200 will be used as the network node in the description that follows.

In some embodiments, a method performed in the User Equipment (UE) in which the UE 1100, upon receiving a UE information request message including the request for the CEF report (connEstFailReportReq), determines if the content of the CEF report logged in the connEstFailReport is the same as (e.g., is equal to) the content of any CEF report entry (in a non-limiting example, the last CEF report entry) in the CEF report list (connEstFailReportList). If the contents are equal, the UE 1100 reports only one of them i.e., either the content of the connEstFailReport or the equivalent entry in the connEstFailReportList and discards/deletes the other one).

FIG. 1 illustrates an example of a scenario in which the CEF report content (connEstFailReport) and the CEF report list (connEstFailReportList) are different, so the UE 1100 shall send both reports to the network. This scenario happens when the UE 1100 experiences a CEF while the CEF report list is already full by having the maximum number of CEF items/entries (in this example 4 CEF items) being already logged. As illustrated in FIG. 1, after the first connection establishment failure (CEF), CEF 1, the UE 1100 logs CEF information in the CEF report (connEstFailReport) and the CEF report list (connEstFailReportList entry #1). This process occurs after each CEF up to the point of where the CEF report list is full with the maximum number of CEF entries (in FIG. 1, entry #1 to entry #4). The UE 1100 indicates the availability of a CEF report to the network node upon transitioning to connected mode. The network node 1200 transmits a request to fetch the CEF report to the UE 1100. For example, in some embodiments, the network node 1200 performs a UE information Request procedure. The UE transmits both the CEF report (e.g., connEstFailReport) and the CEF report list (e.g., connEstFailReportList) to the network node 1200.

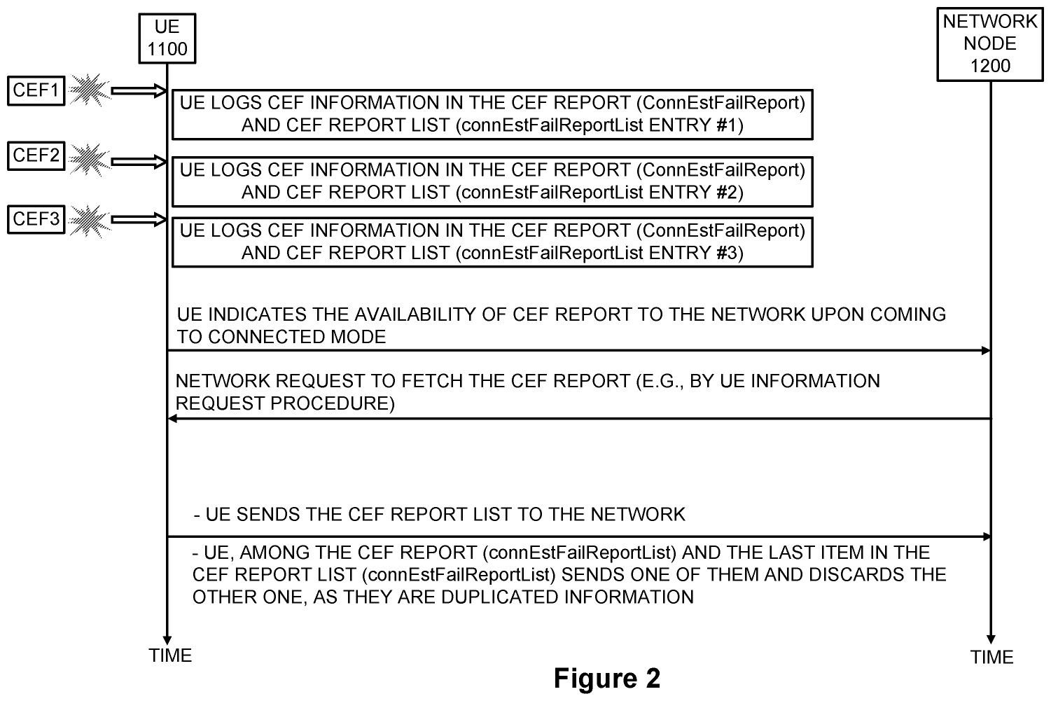

FIG. 2 illustrates a scenario in which the CEF report content (connEstFailReport) and the CEF report list (connEstFailReportList) are the same (i.e., duplicated reports), so the UE 1100 sends only one of these duplicated reports and discard the other one. In one example, the UE 1100 discards the CEF report (connEstFailReport) and sends the entire list of CEF report list (connEstFailReportList) to the network. In another example the UE 1100 sends the CEF report (connEstFailReport) to the network and discards the last entry of the CEF report list (which in FIG. 2 is connEstFailReportList entry #3) when sending the CEF report list to the network.

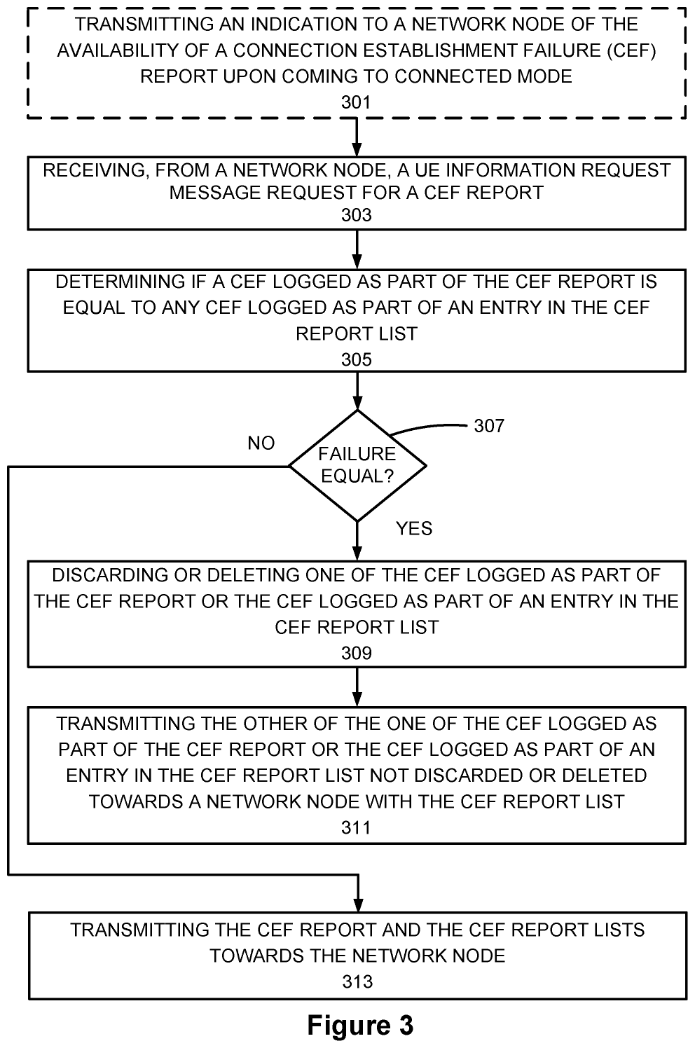

FIGS. 3-7 illustrate operations that the UE 1100 performs in some embodiments. Turning to FIG. 3, in optional block 301, the UE 1100 transmits an indication to a network node 1200 of the availability of a connection establishment failure (CEF) report upon the UE 1100 coming to (e.g., entering) connected mode. In block 303, the UE 1100 receives, from the network node 1200, a UE information request for a CEF report. The network node 1200 may request a CEF report without having received the indication in block 301.

In block 305, the UE 1100 determines if a CEF logged as part of the CEF report is equal to any CEF logged as part of an entry in the CEF report list. For example, if the CEF report content is equal to the content of the last entry in the CEF report list or the same as any of the CEF reports in the CEF report list, then the CEF logged as part of the CEF report is equal to one of the CEF logged as part of an entry in the CEF report list.

Responsive to the CEF logged as part of the CEF report is equal to a CEF logged as part of an entry in the CEF report list as illustrated by decision block 307, the UE 1100 in block 309 discards or deletes one of the CEF logged as part of the CEF report or the CEF logged as part of an entry in the CEF report list. In block 311, the UE 1600 transmits the other of the one of failure logged as part of the CEF report or the failure logged as one of the entries in the CEF report list not discarded or deleted towards the network 1200 with the CEF report list. For example, in some embodiments the UE 1100 discards or deletes the CEF logged as part of the CEF report and transmits the entire CEF report list to the network node 1200. In some other embodiments, the UE 100 discards or deletes the CEF logged as part of an entry in the CEF report list and transmits the rest of the of CEF reports, including the CEF report and the remaining items in CEF report list (after discarding the CEF logged as part of an entry), to the network node 1200.

In some embodiments, the UE 1100 may imply the CEF logged as part of the CEF report is equal to a CEF logged as part of an entry in the CEF report list by not signaling the CEF report list to the network if the CEF report list only had one entry, and this one entry was associated to the identified CEF, and it was discarded or deleted as described above.

Responsive to the CEF logged as part of the CEF report is not equal to a CEF logged as part of an entry in the CEF report list as illustrated by decision block 307, the UE 1100 in block 313 transmits the CEF report and the CEF report list towards the network node 1200.

FIG. 4 illustrates operations the UE 1100 can perform when the UE 1100 is configured with a time window during which, if multiple CEFs are experienced for the same cell, only one CEF report should be generated, even if the CEFs experienced for the same cell are not consecutive. In these embodiments, the UE 1100 has been configured with a timer that regulates how to keep CEF reports for the same failure cell. This timer shall be called a retainability timer.

Turning to FIG. 4, in block 401, the UE 1100 starts a retainability timer that provides a timer for a time window. In an example scenario, a UE experiences a CEF in cell A, then in Cell B, and then in Cell A again.

If the two failures for Cell A occurred within the retainability timer time window, the UE 1100 shall store only the latest copy of the CEF report for Cell A. Thus, in block 403, the UE 1100, responsive to a plurality of CEFs occurring in a same cell within the time window, stores only a latest copy of the CEF report for the same cell.

In this case, the UE may report a numberOfConnFail-r16 that states the number of CEF occurred for Cell A within the retainability timer. Thus, in block 405, the UE 1100 indicates a number of CEFs that occurred in the same cell during the time window to the network node 1200. The UE 1100 may also report a flag indicating of whether the CEF reports for Cell A correspond to consecutive failures or to nonconsecutive failures. Thus, in block 407, the UE 1100 reports a flag indicating whether the CEF reports for the same cell correspond to consecutive failures or non-consecutive failures. In the example above, where a CEF to cell B occurs in between two failures for cell A, the flag would indicate that the CEF reports are not consecutive.

The embodiments described in FIG. 4 would allow the UE 1100 to compress the list of CEF reports and save bits in the signalling of the CEF report list.

In another embodiment, the CEF reports generated by the UE 1100 as part of the CEF report list may not require the UE 1100 to maintain a running timer in order to set the timeSinceFailure-r16. The UE 1100 may instead store a time stamp taken with respect to a UE internal clock, at the time of the occurrence of a CEF generating a CEF report. Thus, as illustrated in FIG. 5, in block 501, the UE 1100 stores a time stamp taken with respect to an internal clock of the UE at a time of the occurrence of a CEF generating a CEF report. When the CEF report needs to be signaled to the network node 1200, the UE 1100 may simply calculate the difference between the time stamp at which the CEF occurred and the time at which the CEF report is signaled to the network node 1200. This approach may save processing power at the UE 1100 as the UE 1100 would not need to run separate timers per CEF.

FIG. 6 illustrates embodiments where the UE 1100 logs CEF information in both a CEF report and a CEF report list avoiding duplication of information. Turning to FIG. 6, in block 601, the UE 1100 responsive to experiencing a first connection establishment failure, CEF, logs CEF related information as part of the CEF report. In some embodiments, the UE 1100 only logs CEF related information as part of the CEF report. In block 603, the UE 1100 experiences a second CEF and, in some embodiments, determines if the first CEF and the second CEF belong to a same cell or different cells.

Upon experiencing the second CEF (i.e., responsive to the second CEF occurring) in a different cell than a cell where the first CEF occurred as indicated by the different decision path in decision block 605, the UE 1100 in block 607 logs the CEF report as an entry of the CEF report list. In block 609, the UE 1100 updates the CEF report with second CEF information associated with the second CEF.

Upon experiencing the second CEF (i.e., responsive to the second CEF occurring) in a same cell as the cell where the first CEF occurred as indicated by the same decision path in decision block 605, the UE 1100 in block 611 updates the CEF report with the second CEF information associated with the second CEF.

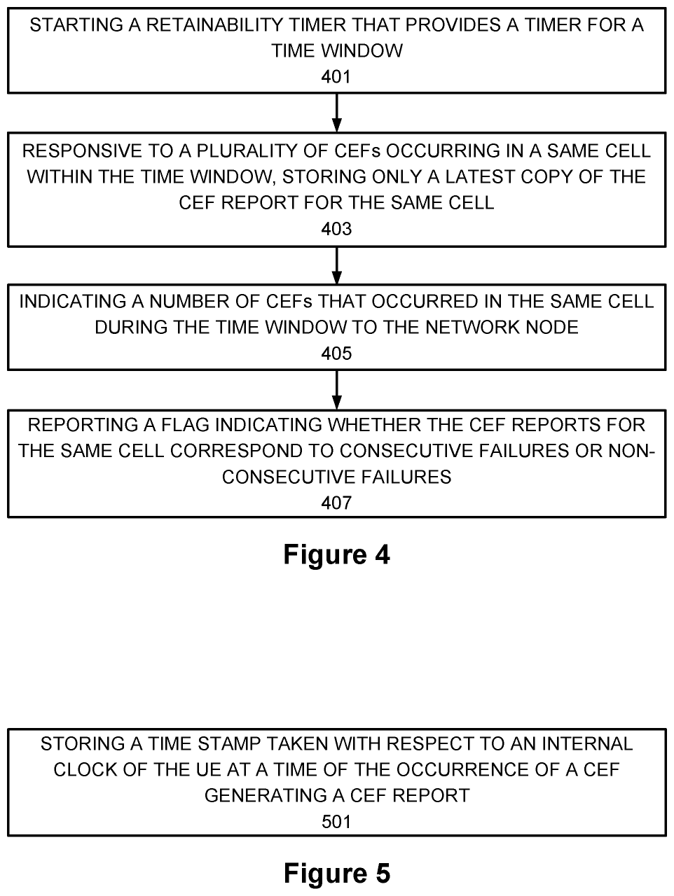

FIG. 7 illustrates a scenario where a network node 1200 receives a CEF report and CEF report list from the UE 1100, extracts the reports from the CEF report list and forwards the reports to the other network nodes (e.g., radio access network (RAN) nodes) in which the CEFs occurred according to the cell ID provided as part of CEF reports. The network node 1200 discards the one of the reports if they are duplicated for example of the content of the CEF report and the last entry of the CEF report list are the same, the network node 1200 removes (e.g., discards/deletes) one of these reports and sends only one of them to the corresponding network node in which the failure occurred in one of its serving cells.

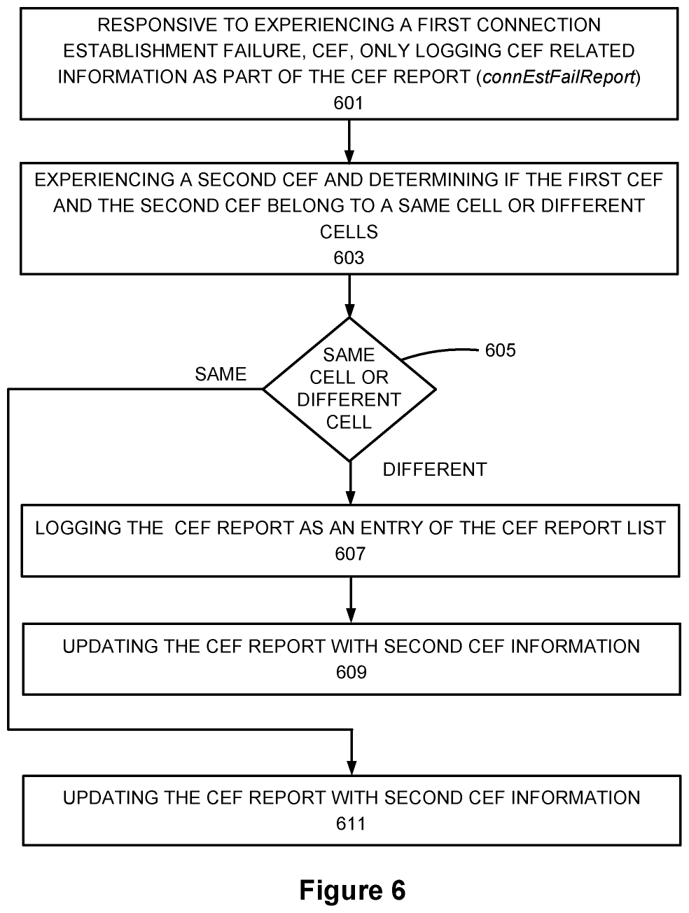

FIG. 8 illustrates operations the network node 1200 performs in some embodiments. Turning to FIG. 8, in block 801, the network node 1200 receives a connection establishment failure, CEF, report and a CEF report list from a user equipment, UE, 1100. The network node 1200, in block 803, determines if a CEF logged as part of the CEF report is a same CEF logged to any CEF logged as part of an entry in the CEF report list.

Responsive to the CEF logged as part of the CEF report is the same CEF logged as part of an entry in the CEF report list as indicated by the yes decision path in decision block 805, the network node 1200 in block 807 removes one of the CEF logged as part of the CEF report or the CEF logged as part of an entry in the CEF report list.

In block 809, the network node 1200 transmits the other of the one of the CEF logged as part of the CEF report or the CEF logged as part of an entry in the CEF report list not removed towards a second network node with the CEF report list. In some embodiments, the network node 1200 discards one of these reports from the CEF report list and dispatches/sends each of the CEF Reports to a second network node. The target network node to which a CEF report is signaled may be the node serving the cell where the CEF occurred. Routing of the CEF report may be based on the Cell Identity of the Cell where the failure occurred.

Responsive to the CEF logged as part of the CEF report is not equal to (i.e., is not the same as) a CEF logged as part of an entry in the CEF report list as indicated by the “no” decision path in decision block 805, the network node 1200 in block 811 forwards each CEF reported in the CEF report and the CEF report list towards corresponding network nodes in which the CEFs occurred based on a cell ID provided in the CEF reports.

In some other embodiments, responsive to the CEF logged as part of the CEF report is the same CEF logged as part of an entry in the CEF report list, the network node 1100 flags the CEF reports that are the same (i.e., are duplicated) and sends both of the reports to the second network node in which the CEF occurred. This is illustrated in block 901 of FIG. 9 where the network node 1200 flags the CEF reports that are the same and sends the CEF reports that are the same to the second network node in which the CEF occurred.

It is worth noting that when CEF reports are signaled over RAN interfaces such as the X2, Xn and F1, they might be signaled via non-UE associated procedures. Namely, the receiving node would not be able to determine for which UE 1100 a received CEF report corresponds. This is because the UE that experiences a CEF is either in Idle Mode or in Inactive Mode, therefore it is not for sure that the RAN node where the UE will report the CEF report or CEF Report List has a UE context for this UE, nor it is for sure that the node where a CEF Report may be forwarded by another RAN node would have a UE context for the UE that experienced the CEF.

As a result, a network node that receives duplicate CEF reports may not be able to deduce that the CEF reports belong to the same UE and that the duplicate reports account for the same failure. This is why it is important and advantageous that the network node 1200 retrieving the CEF reports from the UE 1100 performs detection of the duplicate CEF reports and discards any duplication therein,

In some embodiment, the second network node can be a gNB, a CU-CP (centralized unit-control plane), or a gNB-DU (distributed unit) or a TCE (trace collection entity) or a SMO (service management and orchestration) node.

An example implementation of the embodiments described in FIGS. 1-8 shall now be illustrated. Possible changes are captured in the below text with double underlines.

### 5.7.10.3 Reception of the UEInformationRequest Message

Upon receiving the UEInformationRequest message, the UE shall, only after successful security activation:
1> if the idleModeMeasurementReq is included in the UEInformationRequest and the UE has stored VarMeasIdleReport that contains measurement information concerning cells other than the PCell:
   2> set the measResultIdleEUTRA in the UEInformationResponse message to the value of measReportIdleEUTRA in the VarMeasIdleReport, if available;
   2> set the measResultIdleNR in the UEInformationResponse message to the value of measReportIdleNR in the VarMeasIdleReport, if available;
   2> discard the VarMeasIdleReport upon successful delivery of the UEInformationResponse message confirmed by lower layers;
1> if the logMeasReportReq is present and if the RPLMN is included in plmn-IdentityList stored in VarLogMeasReport:
   2> if VarLogMeasReport includes one or more logged measurement entries, set the contents of the logMeasReport in the UEInformationResponse message as follows:
      3> include the absoluteTimeStamp and set it to the value of absoluteTimeInfo in the VarLogMeasReport;
      3> include the traceReference and set it to the value of traceReference in the VarLogMeasReport;
      3> include the traceRecordingSessionRef and set it to the value of traceRecordingSessionRef in the VarLogMeasReport;
      3> include the tce-Id and set it to the value of tce-Id in the VarLogMeasReport;
      3> include the logMeasInfoList and set it to include one or more entries from the VarLogMeasReport starting from the entries logged first, and for each entry of the logMeasInfoList that is included, include all information stored in the corresponding logMeasInfoList entry in VarLogMeasReport;
      3> if the VarLogMeasReport includes one or more additional logged measurement entries that are not included in the logMeasInfoList within the UEInformationResponse message:
         4> include the logMeasAvailable;
         4> if bt-LocationInfo is included in locationInfo of one or more of the additional logged measurement entries in VarLogMeasReport that are not included in the logMeasInfoList within the UEInformationResponse message:
         5> include the logMeasAvailableBT;
         4> if wlan-LocationInfo is included in locationInfo of one or more of the additional logged measurement entries in VarLogMeasReport that are not included in the logMeasInfoList within the UEInformationResponse message:
         5> include the logMeasAvailableWLAN;
1> if ra-ReportReq is set to true and the UE has random access related information available in VarRA-Report and if the RPLMN is included in plmn-IdentityList stored in VarRA-Report:
   2> set the ra-ReportList in the UEInformationResponse message to the value of ra-ReportList in VarRA-Report;
   2> discard the ra-ReportList from VarRA-Report upon successful delivery of the UEInformationResponse message confirmed by lower layers;
1> if rlf-ReportReq is set to true:
   2> if the UE has radio link failure information or handover failure information available in VarRLF-Report and if the RPLMN is included in plmn-IdentityList stored in VarRLF-Report:
      3> set timeSinceFailure in VarRLF-Report to the time that elapsed since the last radio link failure or handover failure in NR;
      3> set the rlf-Report in the UEInformationResponse message to the value of rlf-Report in VarRLF-Report;
      3> discard the rlf-Report from VarRLF-Report upon successful delivery of the UEInformationResponse message confirmed by lower layers;
   2> else if the UE is capable of cross-RAT RLF reporting as defined in TS 38.306 and has radio link failure information or handover failure information available in VarRLF-Report of TS 36.331 and if the RPLMN is included in plmn-IdentityList stored in VarRLF-Report of TS 36.331:
      3> set timeSince Failure in VarRLF-Report of TS 36.331 to the time that elapsed since the last radio link failure or handover failure in EUTRA;
      3> set failedPCellId-EUTRA in the rlf-Report in the UEInformationResponse message to indicate the PCell in which RLF was detected or the source PCell of the failed handover in the VarRLF-Report of TS 36.331;
      3> set the measResult-RLF-Report-EUTRA in the rlf-Report in the UEInformationResponse message to the value of rlf-Report in VarRLF-Report of TS 36.331;
      3> discard the rlf-Report from VarRLF-Report of TS 36.331 upon successful delivery of the UEInformationResponse message confirmed by lower layers;
1> if connEstFailReportReq is set to true and the UE has connection establishment failure or connection resume failure information in VarConnEstFailReport or VarConnEstFailReportList and if the RPLMN is equal to plmn-Identity stored in VarConnEstFailReport:
   2> set timeSinceFailure in VarConnEstFailReport and timeSinceFailure for the last entry in the connEstFailReportList to the time that elapsed since the last connection establishment failure or connection resume failure in NR;
   2> set the connEstFailReport in the UEInformationResponse message to the value of connEstFailReport in VarConnEstFailReport;
   2> for each connEstFailReport in the connEstFailReportList in the UEInformationResponse message, set the value to the value of connEstFailReport in VarConnEstFailReport in VarConnEstFailReportList except the last entry, if the content of connEstFailReport in the VarConnEstFailReport is equal to the content of the last entry in the VarConnEstFailReportList;
   2> discard the connEstFailReport from VarConnEstFailReport and VarConnEstFailReportList upon successful delivery of the UEInformationResponse message confirmed by lower layers;

Another example implantation of the embodiments described in FIGS. 1-6 shall now be described. Possible changes are captured in the below text with double underlines.

### 5.7.10.3 Reception of the UEInformationRequest Message

Upon receiving the UEInformationRequest message, the UE 1100 shall, only after successful security activation:
1> if the idleModeMeasurementReq is included in the UEInformationRequest and the UE has stored VarMeasIdleReport that contains measurement information concerning cells other than the PCell:
   2> set the measResultIdleEUTRA in the UEInformationResponse message to the value of measReportIdleEUTRA in the VarMeasIdleReport, if available;
   2> set the measResultIdleNR in the UEInformationResponse message to the value of measReportIdleNR in the VarMeasIdleReport, if available;
   2> discard the VarMeasIdleReport upon successful delivery of the UEInformationResponse message confirmed by lower layers;
1> if the logMeasReportReq is present and if the RPLMN is included in plmn-IdentityList stored in VarLogMeasReport:
   2> if VarLogMeasReport includes one or more logged measurement entries, set the contents of the logMeasReport in the UEInformationResponse message as follows:
      3> include the absoluteTimeStamp and set it to the value of absoluteTimeInfo in the VarLogMeasReport;
      3> include the traceReference and set it to the value of traceReference in the VarLogMeasReport;
      3> include the traceRecordingSessionRef and set it to the value of traceRecordingSessionRef in the VarLogMeasReport;
      3> include the tce-Id and set it to the value of tce-Id in the VarLogMeasReport;
      3> include the logMeasInfoList and set it to include one or more entries from the VarLogMeasReport starting from the entries logged first, and for each entry of the logMeasInfoList that is included, include all information stored in the corresponding logMeasInfoList entry in VarLogMeasReport;
      3> if the VarLogMeasReport includes one or more additional logged measurement entries that are not included in the logMeasInfoList within the UEInformationResponse message:
         4> include the logMeasAvailable;
         4> if bt-LocationInfo is included in locationInfo of one or more of the additional logged measurement entries in VarLogMeasReport that are not included in the logMeasInfoList within the UEInformationResponse message:
         5> include the logMeasAvailableBT;
         4> if wlan-LocationInfo is included in locationInfo of one or more of the additional logged measurement entries in VarLogMeasReport that are not included in the logMeasInfoList within the UEInformationResponse message:
         5> include the logMeasAvailableWLAN;
1> if ra-ReportReq is set to true and the UE has random access related information available in VarRA-Report and if the RPLMN is included in plmn-IdentityList stored in VarRA-Report:
   2> set the ra-ReportList in the UEInformationResponse message to the value of ra-ReportList in VarRA-Report;
   2> discard the ra-ReportList from VarRA-Report upon successful delivery of the UEInformationResponse message confirmed by lower layers;
1> if rlf-ReportReq is set to true:
   2> if the UE has radio link failure information or handover failure information available in VarRLF-Report and if the RPLMN is included in plmn-IdentityList stored in VarRLF-Report:
      3> set timeSinceFailure in VarRLF-Report to the time that elapsed since the last radio link failure or handover failure in NR;
      3> set the rlf-Report in the UEInformationResponse message to the value of rlf-Report in VarRLF-Report;
      3> discard the rlf-Report from VarRLF-Report upon successful delivery of the UEInformationResponse message confirmed by lower layers;
   2> else if the UE is capable of cross-RAT RLF reporting as defined in TS 38.306 and has radio link failure information or handover failure information available in VarRLF-Report of TS 36.331 and if the RPLMN is included in plmn-IdentityList stored in VarRLF-Report of TS 36.331:
      3> set timeSince Failure in VarRLF-Report of TS 36.331 to the time that elapsed since the last radio link failure or handover failure in EUTRA;
      3> set failedPCellId-EUTRA in the rlf-Report in the UEInformationResponse message to indicate the PCell in which RLF was detected or the source PCell of the failed handover in the VarRLF-Report of TS 36.331;
      3> set the measResult-RLF-Report-EUTRA in the rlf-Report in the UEInformationResponse message to the value of rlf-Report in VarRLF-Report of TS 36.331;
      3> discard the rlf-Report from VarRLF-Report of TS 36.331 upon successful delivery of the UEInformationResponse message confirmed by lower layers;
1> if connEstFailReportReq is set to true and the UE has connection establishment failure or connection resume failure information in VarConnEstFailReport or VarConnEstFailReportList and if the RPLMN is equal to plmn-Identity stored in VarConnEstFailReport:
   2> if the content of connEstFailReport in the VarConnEstFailReport is NOT equal to the content of the last entry in the VarConnEstFailReportList
      3> set timeSinceFailure in VarConnEstFailReport to the time that elapsed since the last connection establishment failure or connection resume failure in NR;
      3> set the connEstFailReport in the UEInformationResponse message to the value of connEstFailReport in VarConnEstFailReport;
   2> for each connEstFailReport in the connEstFailReportList in VarConnEstFailReportList:
      3> set timeSinceFailure to the time that elapsed since the associated connection establishment failure or connection resume failure in NR
   2> for each connEstFailReport in the connEstFailReportList in the UEInformationResponse message, set the value to the value of connEstFailReport in VarConnEstFailReport in VarConnEstFailReportList;
   2> discard the connEstFailReport from VarConnEstFailReport and VarConnEstFailReportList upon successful delivery of the UEInformationResponse message confirmed by lower layers;
1> if the mobilityHistoryReportReq is set to true:
   2> include the mobilityHistoryReport and set it to include visitedCellInfoList from VarMobilityHistoryReport;
   2> include in the mobilityHistoryReport an entry for the current PCell, possibly after removing the oldest entry if required, and set its fields as follows:
      3> set visitedCellId to the global cell identity or the physical cell identity and carrier frequency of the current PCell:
      3> set field timeSpent to the time spent in the current PCell;
      3> if visitedPSCellInfoList is present in VarMobilityHistoryReport:
         4> for the newest entry of the PCell in the mobiliyHistoryReport, include visitedPSCellInfoList from VarMobilityHistoryReport;
         4> if the UE is configured with a PSCell:
         5> for the newest entry of the PCell in the mobiliyHistoryReport, include the current PSCell information in the visitedPSCellInfoList, possibly after removing the oldest entry, if required, and set its fields as follows:
         6> set visitedCellld to the global cell identity or the physical cell identity and carrier frequency of the current PSCell:
         6> set field timeSpent to the time spent in the current PSCell while being connected to the current PCell;
         4> else:
         5> for the newest entry of the PCell in the mobiliyHistoryReport, include a new entry in the visitedPSCellInfoList, possibly after removing the oldest entry, if required, and set its fields as follows:
         6> set field timeSpent to the time spent without PSCell in the current PCell since last PSCell release or secondary cell radio link failure since connected to the current PCell in RRC_CONNECTED;
      3> else:
         4> if the UE is configured with a PSCell:
         5> for the newest entry of the PCell in the mobiliyHistoryReport, include the current PSCell information in the visitedPSCellInfoList, possibly after removing the oldest entry, if required, and set its fields as follows:
         6> set visitedCellld to the global cell identity or the physical cell identity and carrier frequency of the current PSCell:
         6> set field timeSpent to the time spent in the current PSCell while being connected to the current PCell;
         4> else:
         5> for the newest entry of the PCell in the mobiliyHistoryReport, include a new entry in the visitedPSCellInfoList, possibly after removing the oldest entry, if required, and set its fields as follows:
         6> set field timeSpent to the time spent without PSCell in the current PCell since connected to the current PCell in RRC_CONNECTED;
1> if the successHO-ReportReq is set to true and if the RPLMN is included in the plmn-IdentityList stored in VarSuccessHO-Report:
   2> if the successHO-Report in the VarSuccessHO-Report concerns a DAPS handover:
      3> set upInterruptionTimeAtHO in VarSuccessHO-Report to include the time elapsed between the time of arrival of the last PDCP PDU received from the source cell of the concerned handover and the time of arrival of the first non-duplicate PDCP PDU received from the target cell of the concerned handover, as measured at the time of arrival of the first non-duplicate PDCP PDU received from the target cell
   2> set the successHO-Report in the UEInformationResponse message to the value of successHO-Report in the VarSuccessHO-Report, if available;
   2> discard the VarSuccessHO-Report upon successful delivery of the UEInformationResponse message confirmed by lower layers;
1> if the logMeasReport is included in the UEInformationResponse:
   2> submit the UEInformationResponse message to lower layers for transmission via SRB2;
   2> discard the logged measurement entries included in the logMeasInfoList from VarLogMeasReport upon successful delivery of the UEInformationResponse message confirmed by lower layers;
1> else:
   2> submit the UEInformationResponse message to lower layers for transmission via SRB1.

Example implantation of the embodiments described in FIG. 6. Possible changes are captured in the below text with double underlines for additions and strikethrough for deletions.

5.3.13.5 T319 Expiry or Integrity Check Failure from Lower Layers while T319 is Running

The UE shall:
1> if timer T319 expires:
   2> if the UE supports multiple CEF report:
      3> if the UE has connection establishment failure information or connection resume failure information available in VarConnEstFailReport and if the RPLMN is equal to plmn-identity stored in VarConnEstFailReport; and
      3> if the cell identity of current cell is not equal to the cell identity stored in measResult FailedCell in VarConnEstFailReport and if the maxCEFReport-r17 has not been reached:
         4> append the VarConnEstFailReport as a new entry in the VarConnEstFailReportList;
   2> if the UE has connection establishment failure information or connection resume failure information available in VarConnEstFailReport and if the RPLMN is not equal to plmn-identity stored in VarConnEstFailReport; or
   2> if the cell identity of current cell is not equal to the cell identity stored in measResultFailedCell in VarConnEstFailReport:
      3> reset the numberOfConnFail to 0;
   2> if the UE has connection establishment failure information or connection resume failure information available in VarConnEstFailReportList and if the RPLMN is not equal to plmn-identity stored in VarConnEstFailReportList:
      3> clear the content included in VarConnEstFailReportList;
   2> clear the content included in VarConnEstFailReport except for the numberOfConnFail, if any;
   2> store the following connection resume failure information in the VarConnEstFailReport by setting its fields as follows:
      3> set the plmn-Identity to the PLMN selected by upper layers (see TS 24.501) from the PLMN(s) included in the plmn-IdentityInfoList in SIB1;
      3> set the measResultFailedCell to include the global cell identity, tracking area code, the cell level and SS/PBCH block level RSRP, and RSRQ, and SS/PBCH block indexes, of the failed cell based on the available SSB measurements collected up to the moment the UE detected connection resume failure;
      3> if available, set the measResultNeighCells, in order of decreasing ranking-criterion as used for cell re-selection, to include neighbouring cell measurements for at most the following number of neighbouring cells: 6 intra-frequency and 3 inter-frequency neighbours per frequency as well as 3 inter-RAT neighbours, per frequency/set of frequencies per RAT and according to the following:
         4> for each neighbour cell included, include the optional fields that are available;
   NOTE: The UE includes the latest results of the available measurements as used for cell reselection evaluation, which are performed in accordance with the performance requirements as specified in TS 38.133.
      3> if available, set the locationInfo as in 5.3.3.7;
      3> set perRAInfoList to indicate the performed random access procedure related information as specified in 5.7.10.5;
      3> if numberOfConnFail is smaller than 8:
         4> increment the numberOfConnFail by 1;
   2> perform the actions upon going to RRC_IDLE as specified in 5.3.11 with release cause ‘RRC Resume failure’.
1> else if upon receiving Integrity check failure indication from lower layers while T319 is running:
   2> perform the actions upon going to RRC_IDLE as specified in 5.3.11 with release cause ‘RRC Resume failure’.

The UE may discard the connection resume failure or connection establishment failure information, i.e., release the UE variable VarConnEstFailReport, 48 hours after the last connection resume failure is detected.

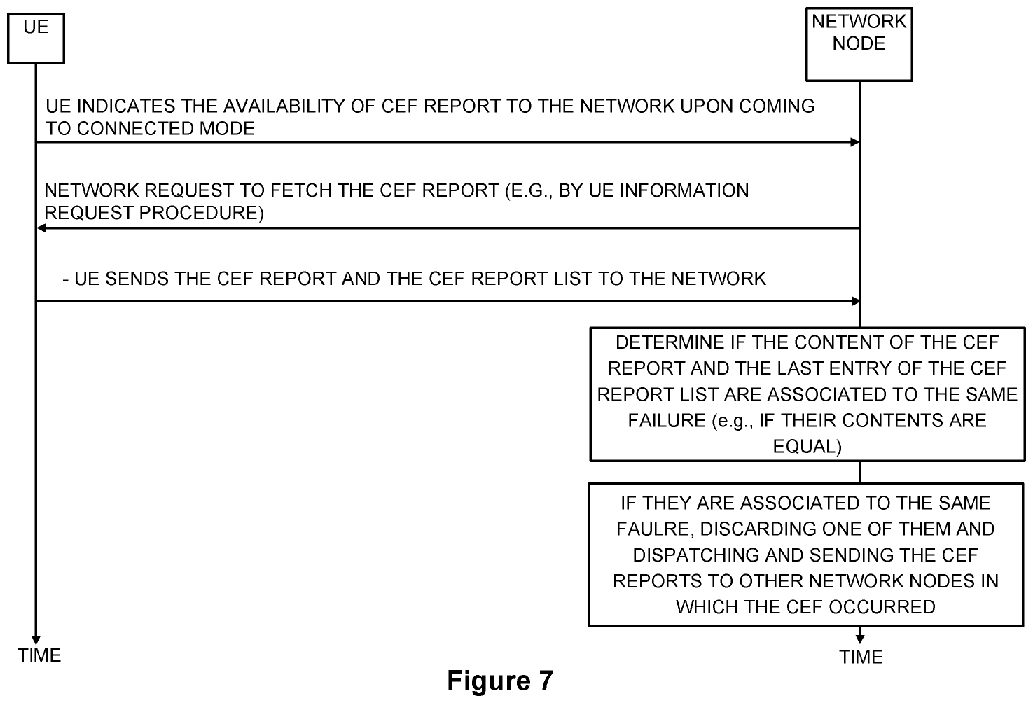

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010A and 1010B (one or more of which may be generally referred to as network nodes 1010), or any other similar 3rd Generation Partnership Project (3GPP) access node or non-3GPP access point. The network nodes 1010 facilitate direct or indirect connection of user equipment (UE), such as by connecting UEs 1012A, 1012B, 1012C, and 1012D (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012C and/or 1012D) and network nodes (e.g., network node 1010B). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010B. The hub 1014 may also allow for a different communication scheme and/or schedule between the hub 1014 and UEs (e.g., UE 1012C and/or 1012D), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010B. In other embodiments, the hub 1014 may be a non-dedicated hub—that is, a device which is capable of operating to route communications between the UEs and network node 1010B, but which is additionally capable of operating as a communication start and/or end point for certain data channels.

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 10 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

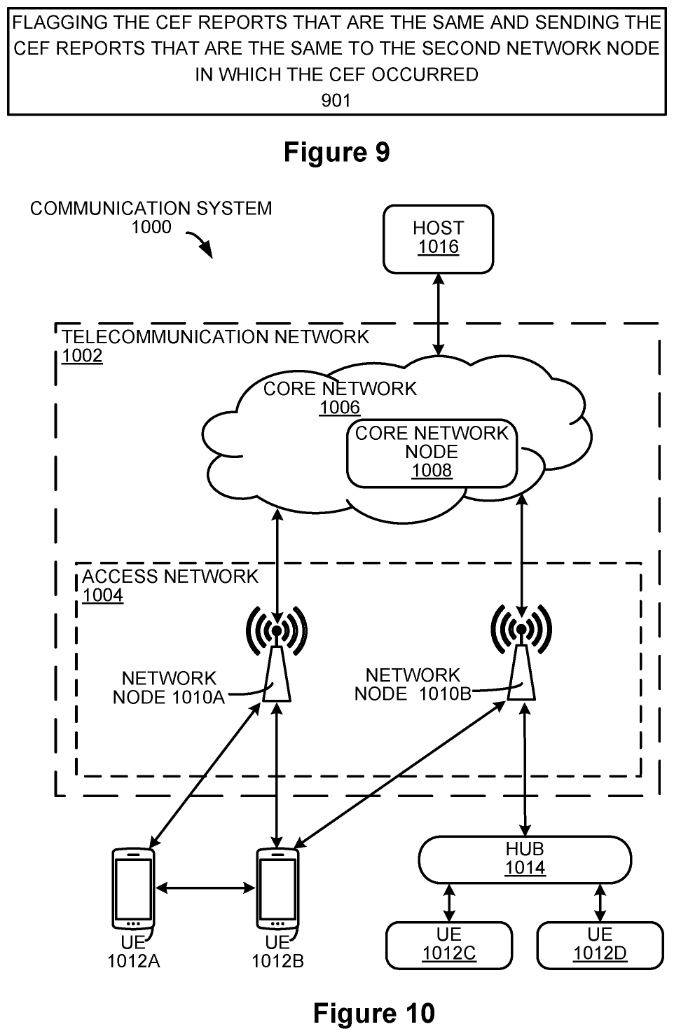

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

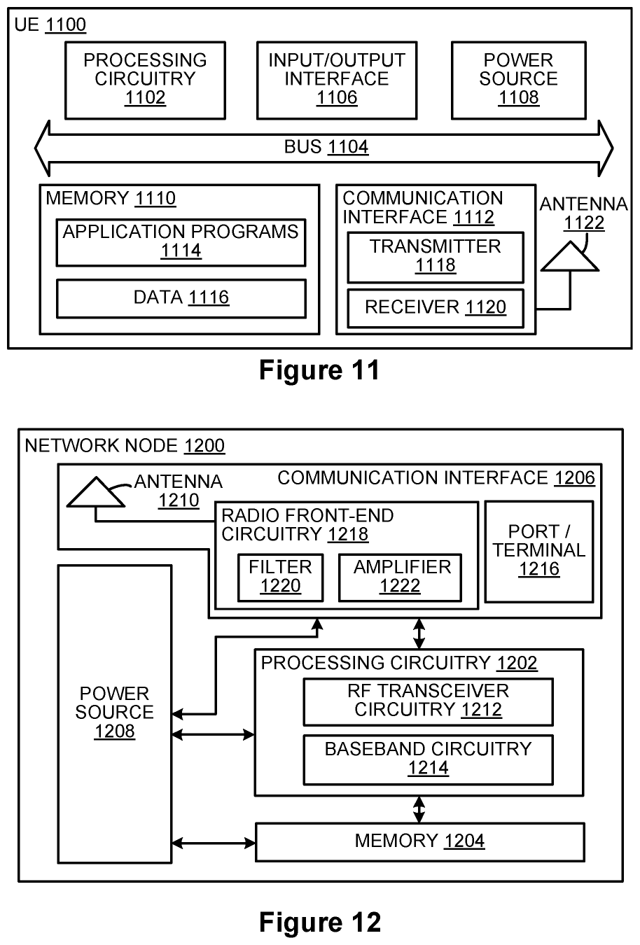

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

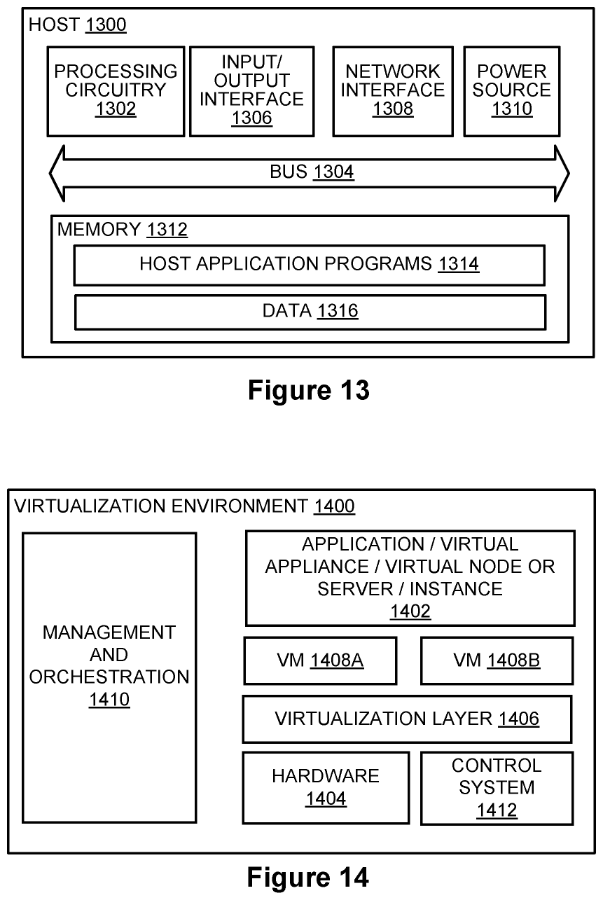

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408A and 1408B (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

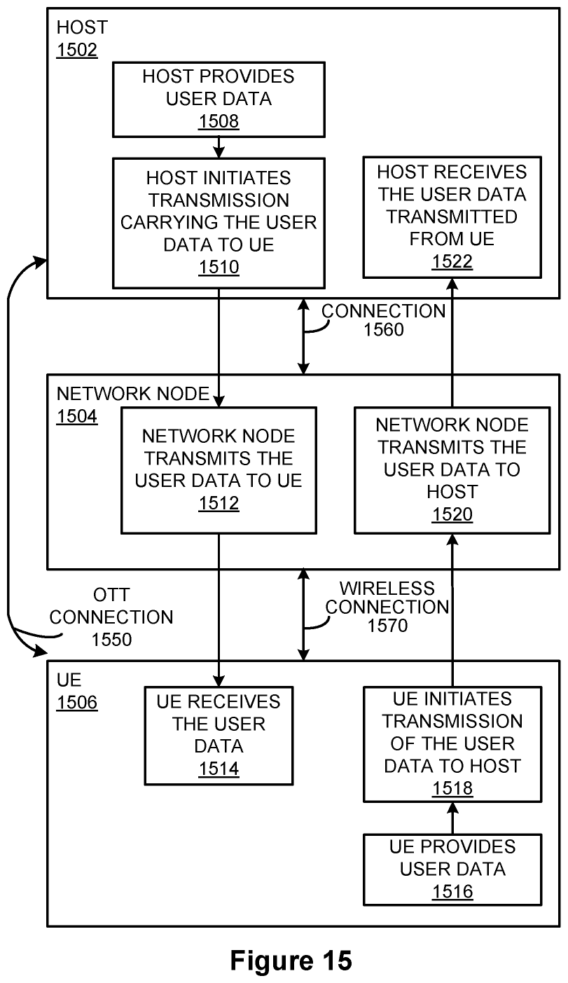

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012A of FIG. 10 and/or UE 1100 of FIG. 11), network node (such as network node 1010A of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Embodiments

1. A method performed in a user equipment, UE (1012A-D, 1100, 1402, 1506) the method comprising:
receiving (303), from a network node (1010A, 1010B, 1200, 1402, 1504), a UE information request message including a request for a connection establishment failure, CEF, report;
determining (305) if a CEF logged as part of the CEF report is equal to any CEF logged as part of an entry in the CEF report list;
responsive to the CEF logged as part of the CEF report is equal (307) to a CEF logged as part of an entry in the CEF report list:
   discarding or deleting (309) one of the CEF logged as part of the CEF report or the CEF logged as part of an entry in the CEF report list; and
   transmitting (311) the other of the one of failure logged as part of the CEF report or the failure logged as one of the entries in the CEF report list not discarded or deleted towards the network node (1010A, 1010B, 1200, 1402, 1504) with the CEF report list; and
responsive to the CEF logged as part of the CEF report is not equal (307) to the CEF logged as part of an entry in the CEF report list:
   transmitting (313) the CEF report and the CEF report list towards the network node (1010A, 1010B, 1200, 1402, 1504).

2. The method of Embodiment 1, further comprising:
transmitting (301) an indication to the network node (1010A, 1010B, 1200, 1402, 1504) of the availability of a CEF report upon coming to connected mode.

3. The method of any of Embodiments 1-2, further comprising starting (401) a retainability timer that provides a timer for a time window.

4. The method of Embodiment 3, further comprising:
responsive to a plurality of CEFs occurring in a same cell within the time window, storing (403) only a latest copy of the CEF report for the same cell.

5. The method of any of Embodiments 3-4, further comprising
indicating (405) a number of CEFs that occurred in the same cell during the time window to the network node.

6. The method of any of Embodiments 3-5, further comprising:
reporting (407) a flag indicating whether the CEF reports for the same cell correspond to consecutive failures or to non-consecutive failures.

7. The method of any of Embodiments 1-6, further comprising storing (501) a time stamp taken with respect to an internal clock of the UE at a time of the occurrence of a CEF generating a CEF report.

8. A method performed in a user equipment, UE (1012A-D, 1100, 1402, 1506) the method comprising:
responsive to experiencing a first connection establishment failure, CEF, only logging (601) CEF related information as part of the CEF report;
experiencing (603) a second CEF and determining if the first CEF and the second CEF belong to a same cell or different cells;
upon experiencing the second CEF in a different cell than a cell where the first CEF occurred (605):
   logging (607) the CEF report as an entry of the CEF report list; and
   updating (609) the CEF report with second CEF information associated with the second CEF; and
   upon experiencing the second CEF in the cell where the first CEF occurred (605): updating (611) the CEF report with the second CEF information associated with the second CEF.

9. A method performed in a network node (1010A, 1010B, 1200, 1402, 1504), the method comprising:
receiving (801) a connection establishment failure, CEF, report and a CEF report list from a user equipment, UE (1012A-D, 1100, 1402, 1506);
determining (803) if a CEF logged as part of the CEF report is a same CEF logged to any CEF logged as part of an entry in the CEF report list;
responsive to the CEF logged as part of the CEF report is the same CEF logged as part of an entry in the CEF report list (805):
   removing (807) one of the CEF logged as part of the CEF report or the CEF logged as part of an entry in the CEF report list; and
   transmitting (809) the other of the one of the CEF logged as part of the CEF report or the CEF logged as part of an entry in the CEF report list not removed towards a second network node with the CEF report list; and
responsive to the CEF logged as part of the CEF report is not equal to a CEF logged as part of an entry in the CEF report list (805):
   forwarding (811) each CEF reported in the CEF report and the CEF report list towards corresponding network nodes in which the CEFs occurred based on a cell identifier, ID, provided in the CEF reports.

10. The method of Embodiment 9, wherein removing one of the CEF logged as part of the CEF report or the CEF logged as part of an entry in the CEF report list comprises discarding the one of the CEF logged as part of the CEF report or the CEF logged as part of an entry in the CEF report list.

11. The method of any of Embodiments 9-10, wherein transmitting the other of the one of CEF logged as part of the CEF report or the CEF logged as part of an entry in the CEF report list not removed towards a second network node with the CEF report list comprises transmitting the other of the one of CEF logged as part of the CEF report or the CEF logged as part of an entry in the CEF report list not removed towards a corresponding network node in which the CEF occurred based on a cell ID provided in the CEF reports.

12. The method of any of Embodiments 9-11, wherein responsive to the CEF logged as part of the CEF report is the same CEF logged as part of an entry in the CEF report list:
flagging the CEF reports that are the same and sending the CEF reports that are the same to the second network node in which the CEF occurred.

13. A user equipment, UE (1012A-D, 1100, 1402, 1506) comprising:
processing circuitry (1102); and
memory (1110) coupled with the processing circuitry, wherein the memory includes instructions that when executed by the processing circuitry causes the UE (1012A-D, 1100, 1402, 1506) to perform operations according to any of Embodiments 1-8.

14. A user equipment, UE (1012A-D, 1100, 1402, 1506) adapted to perform according to any of Embodiments 1-8.

15. A computer program comprising program code to be executed by processing circuitry ( ) of a user equipment, UE (1012A-D, 1100, 1402, 1506), whereby execution of the program code causes the UE (1012A-D, 1100, 1402, 1506) to perform operations according to any of Embodiments 1-8.

16. A computer program product comprising a non-transitory storage medium including program code to be executed by processing circuitry (1102) of a user equipment, UE (1012A-D, 1100, 1402, 1506), whereby execution of the program code causes the UE (1012A-D, 1100, 1402, 1506) to perform operations according to any of Embodiments 1-8.

17. A network node (1010A, 1010B, 1200, 1402, 1504) comprising:
processing circuitry (1202); and
memory (1204) coupled with the processing circuitry, wherein the memory includes instructions that when executed by the processing circuitry causes the network node to perform operations according to any of Embodiments 9-12.

18. A network node (1010A, 1010B, 1200, 1402, 1504) adapted to perform according to any of Embodiments 9-12.

19. A computer program comprising program code to be executed by processing circuitry (1202) of a network node (1010A, 1010B, 1200, 1402, 1504), whereby execution of the program code causes the network node (1010A, 1010B, 1200, 1402, 1504) to perform operations according to any of Embodiments 9-12.

20. A computer program product comprising a non-transitory storage medium including program code to be executed by processing circuitry (1202) of a network node (1010A, 1010B, 1200, 1402, 1504), whereby execution of the program code causes the network node (1010A, 1010B, 1200, 1402, 1504) to perform operations according to any of Embodiments 9-12.

### REFERENCES ARE IDENTIFIED BELOW

[1] TS 37.320 Radio measurement collection for Minimization of Drive Tests (MDT); Overall description; Stage 2, v 16.7.0
[2] TS 38.331 NR; Radio Resource Control (RRC); Protocol specification. V 16.7.0
[3] R2-2204209 Introducing Enhancement of Data Collection for SON and MDT, rev 2 https://wwwww.3gpp.org/ftp/tsa ran/WG2 RL2/TSGR2_117-e/Inbox/R2-2204209.zip

1. A method performed in a user equipment, UE the method comprising:
responsive to experiencing a first connection establishment failure, CEF, logging information related to the first CEF as part of a CEF report;
experiencing a second CEF;
responsive to the second CEF occurring in a different cell than a cell where the first CEF occurred:
logging the CEF report as an entry of a CEF report list; and
updating the CEF report with information associated with the second CEF.

2. The method of claim 1, further comprising:
responsive to the second CEF occurring in the cell where the first CEF occurred:
updating the CEF report with the second CEF information associated with the second CEF.

3. The method of claim 1, further comprising:
receiving, from a network node, a UE information request message including a request for the CEF report; and
transmitting the CEF report and the CEF report list towards the network node.

4. The method of claim 1, further comprising:
transmitting an indication to the network node of the availability of the CEF report upon coming to connected mode.

5. The method of claim 1, further comprising starting a retainability timer that provides a timer for a time window.

6. The method of claim 5, further comprising:
responsive to a plurality of CEFs occurring in a same cell within the time window, storing only a latest copy of the CEF report for the same cell.

7. The method of claim 5, further comprising
indicating a number of CEFs that occurred in the same cell during the time window to the network node.

8. The method of claim 5, further comprising:
reporting a flag indicating whether the CEF reports for the same cell correspond to consecutive failures or to non-consecutive failures.

9. The method of claim 1, further comprising storing a time stamp taken with respect to an internal clock of the UE at a time of the occurrence of a CEF generating a CEF report.

10. A method performed in a network node, the method comprising:
receiving a connection establishment failure, CEF, report and a CEF report list from a user equipment, UE;
determining if a CEF logged as part of the CEF report is a same CEF logged to any CEF logged as part of an entry in the CEF report list;
responsive to the CEF logged as part of the CEF report is the same CEF logged as part of an entry in the CEF report list:
removing one of the CEF logged as part of the CEF report or the CEF logged as part of an entry in the CEF report list; and
transmitting the other of the one of the CEF logged as part of the CEF report or the CEF logged as part of an entry in the CEF report list not removed towards a second network node with the CEF report list; and
responsive to the CEF logged as part of the CEF report is not equal to a CEF logged as part of an entry in the CEF report list:
forwarding each CEF reported in the CEF report and the CEF report list towards corresponding network nodes in which the CEFs occurred based on a cell identifier, ID, provided in the CEF reports.

11. The method of claim 10, wherein removing one of the CEF logged as part of the CEF report or the CEF logged as part of an entry in the CEF report list comprises discarding the one of the CEF logged as part of the CEF report or the CEF logged as part of an entry in the CEF report list.

12. The method of claim 10, wherein transmitting the other of the one of CEF logged as part of the CEF report or the CEF logged as part of an entry in the CEF report list not removed towards a second network node with the CEF report list comprises transmitting the other of the one of CEF logged as part of the CEF report or the CEF logged as part of an entry in the CEF report list not removed towards a corresponding network node in which the CEF occurred based on a cell ID provided in the CEF reports.

13. The method of claim 10, wherein responsive to the CEF logged as part of the CEF report is the same CEF logged as part of an entry in the CEF report list:
flagging the CEF reports that are the same and sending the CEF reports that are the same to the second network node in which the CEF occurred.

14. A user equipment, UE comprising:
processing circuitry; and
memory coupled with the processing circuitry, wherein the memory includes instructions that when executed by the processing circuitry causes the UE to perform operations according to claim 1.

15-16. (canceled)

17. A computer program product comprising a non-transitory storage medium including program code to be executed by processing circuitry of a user equipment, UE, whereby execution of the program code causes the UE to perform operations according to claim 1.

18. A network node comprising:
processing circuitry; and
memory coupled with the processing circuitry, wherein the memory includes instructions that when executed by the processing circuitry causes the network node to perform operations according to claim 10.

19. A network node adapted to perform according to claim 10.

20. A computer program comprising program code to be executed by processing circuitry of a network node, whereby execution of the program code causes the network node to perform operations according to claim 10.

21. (canceled)
